(19) United States
(12) Patent Application Publication
(10) Pub. No.: US 2020/0073498 A1
(43) Pub. Date: Mar. 5, 2020

(54) TOUCH PANEL AND DISPLAY DEVICE

(71) Applicant: Wuhan China Star Optoelectronics Technology Co., Ltd., Wuhan (CN)

(72) Inventors: Yuehua Yang, Wuhan (CN); Mang Zhao, Wuhan (CN)

(73) Assignees: WUHAN CHINA STAR OPTOELECTRONICS TECHNOLOGY CO., LTD., Wuhan (CN); WUHAN CHINA STAR OPTOELECTRONICS TECHNOLOGY CO., LTD., Wuhan (CN)

(21) Appl. No.: 16/303,342

(22) PCT Filed: Sep. 11, 2018
(86) PCT No.: PCT/CN2018/104929

§ 371 Date: Nov. 20, 2018

(30) Foreign Application Priority Data
Aug. 28, 2018 (CN) 201810990750.6

(51) Int. Cl. G06F 3/041; G06F 3/044; G06F 3/047

(52) U.S. Cl. CPC G06F 3/0412; G02F 1/13338; G06F 3/047; G06F 3/044

(57) ABSTRACT

A touch panel and a display device are disclosed, the touch panel includes a touch unit array, a plurality of touch switches, a plurality of touch wires, and an integrated circuit board, the touch switches are connected to the touch wires, the touch wires connect the touch units to the touch switches, wherein each of the touch units is connected to at least two of the touch wires that evenly distributed within each of the touch units.

### FIELD OF INVENTION

The present disclosure relates to the technical field of displays, and specifically to a touch panel and a display device.

### BACKGROUND OF INVENTION

With development of display panel technology, display devices that adopt a shaped screen and a chamfered screen design, are continuously updated. That brings some screen display problems while improving screen ratio. Unevenness of display brightness of pixels corresponding to touch units is one of problems that need to be solved.

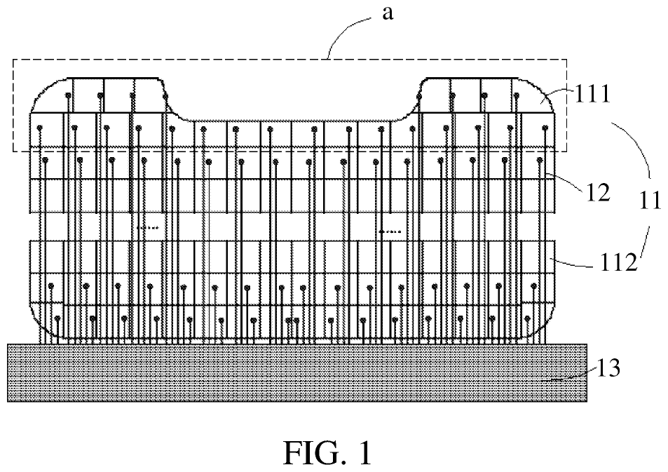

In an embedded liquid display panel, touch units simultaneously act as common electrodes. Structure of a commonly designed touch unit is a regular rectangle. As shown in FIG. 1, since partial regions of full screen adopts design of a chamfered display area and a shaped screen, a pattern of a touch unit 11 at a top end of a screen is no longer as regular, and an area of a first touch unit 111 located in a shaped region a is different from areas of second touch units 112 located in other positions, such that capacitances of adjacent touch units 11 are different. When a display device displays images, the touch unit 11 is subjected to crosstalk between scan signals and data signals, and voltage variations of the touch unit 11 with different capacitances subjected to the crosstalk are different, thereby causing that signal voltages on the touch unit 11 are different, and pixels located in adjacent touch units 11 are different in brightness.

Thus, a touch panel and a display device are urgently needed to solve above problems.

### SUMMARY OF INVENTION

A touch panel and a display device are provided in the present disclosure, which solve a problem that a signal voltage distribution in a pixel area corresponding to a single touch unit in existing touch panel is uneven, thereby causing uneven brightness.

According to one aspect of the present disclosure, a touch panel is provided and includes: a touch unit array, a plurality of touch switches, a plurality of touch wires, and an integrated circuit board, wherein the touch panel comprises a display region and a non-display region around the display region;
wherein the touch unit array comprises a plurality of touch units distributed in the display region in an array manner;
wherein the touch switches are disposed in the non-display region and connected to the touch wires, the touch switches are configured to receive a plurality of signal voltages and transmit the signal voltages to the touch wires, and a number of the touch switches is one-to-one correspondence with a number of the touch switches;
wherein the touch wires connect the touch units to the touch switches, and the touch wires transmit the signal voltages to the touch units;
wherein the integrated circuit board is configured to provide the signal voltages to the touch units; and
wherein each of the touch units is connected to at least two of the touch wires that are evenly distributed within each of the touch units.

In one embodiment of the present disclosure, the touch switches comprises a plurality of thin film transistors, each of the thin film transistors comprises a source, a drain, and a gate; and
the gate is configured to receive a switch voltage for one of the touch switches, the source is configured to receive one of the signal voltages, and the drain is connected to one of the touch wires.

In one embodiment of the present disclosure, the display region comprises a shaped region and a normal region, the shaped region is located on one side of the display region away from the integrated circuit board, and the touch units comprise a plurality of first touch units and a plurality of second touch units; and
wherein the first touch units are disposed in the shaped region, the second touch units are disposed in the normal region, the first touch units and the second touch units both are connected to the integrated circuit board via the touch wires and the touch switches, and an area of each of the first touch units is different from an area of each of the second touch units.

In one embodiment of the present disclosure, each of the first touch units is connected to two of the touch wires located on two sides within each of the first touch units; and
two of the signal voltages are transmitted into each of the first touch units via two of the touch wires.

In one embodiment of the present disclosure, each of the first touch units is connected to m-numbered touch wires evenly distributed within each of the first touch units, and m is an integer greater than or equal to two; and one of the signal voltages are transmitted into each of the first touch units via the m-numbered touch wires.

In one embodiment of the present disclosure, the touch wires comprises a plurality of first touch wires and a plurality of second touch wires, the first touch wires are connected to the touch switches and the integrated circuit board, the second touch wires are connected to the touch switches; and
the touch wires connected to the touch units include one of the first wires.

In one embodiment of the present disclosure, the touch panel includes:

a substrate;
a first metal layer disposed on the substrate;
a first insulating layer disposed on the first metal layer;
a second metal layer disposed on the first insulating layer;
a second insulating layer disposed on the second metal layer;
a third metal layer disposed on the second insulating layer;
a third insulating layer disposed on the third metal layer;
a touch layer disposed on the third metal layer, wherein the touch units are located on the touch layer; and
wherein the touch wires are located on the third metal layer.

In one embodiment of the present disclosure, the touch panel includes:
a substrate;
a first metal layer disposed on the substrate;
a first insulating layer disposed on the first metal layer;
a second metal layer disposed on the first insulating layer;
a second insulating layer disposed on the second metal layer;
a touch layer disposed on the second metal layer, wherein the touch units are located on the touch layer; and
wherein the touch wires are located on the second metal layer.

According to another aspect of the present disclosure, a touch panel is provided and include: a touch unit array, a plurality of touch switches, a plurality of touch wires, and an integrated circuit board, wherein the touch panel comprises a display region and a non-display region around the display region;
wherein the touch unit array comprises a plurality of touch units distributed in the display region in an array manner;
wherein the touch switches are disposed in the non-display region and connected to the touch wires, and the touch switches are configured to receive a plurality of signal voltages and transmit the signal voltages to the touch wires;
wherein the touch wires connect the touch units to the touch switches, and the touch wires transmit the signal voltages to the touch units;
wherein the integrated circuit board is configured to provide the signal voltages to the touch units; and
wherein each of the touch units is connected to at least two of the touch wires that are evenly distributed within each of the touch units.

In one embodiment of the present disclosure, the touch switches comprises a plurality of thin film transistors, each of the thin film transistors comprises a source, a drain, and a gate; and
the gate is configured to receive a switch voltage for one of the touch switches, the source is configured to receive one of the signal voltages, and the drain is connected to one of the touch wires.

In one embodiment of the present disclosure, wherein the display region comprises a shaped region and a normal region, the shaped region is located on one side of the display region away from the integrated circuit board, and the touch units comprise a plurality of first touch units and a plurality of second touch units; and
wherein the first touch units are disposed in the shaped region, the second touch units are disposed in the normal region, the first touch units and the second touch units both are connected to the integrated circuit board via the touch wires and the touch switches, and an area of each of the first touch units is different from an area of each of the second touch units.

In one embodiment of the present disclosure, each of the first touch units is connected to two of the touch wires located on two sides within each of the first touch units; and
two of the signal voltages are transmitted into each of the first touch units via two of the touch wires.

In one embodiment of the present disclosure, each of the first touch units is connected to m-numbered touch wires evenly distributed within each of the first touch units, and m is an integer greater than or equal to two; and
one of the signal voltages are transmitted into each of the first touch units via the m-numbered touch wires.

In one embodiment of the present disclosure, the touch wires comprises a plurality of first touch wires and a plurality of second touch wires, the first touch wires are connected to the touch switches and the integrated circuit board, the second touch wires are connected to the touch switches; and
the touch wires connected to the touch units include one of the first wires.

In one embodiment of the present disclosure, the touch panel includes:
a substrate;
a first metal layer disposed on the substrate;
a first insulating layer disposed on the first metal layer;
a second metal layer disposed on the first insulating layer;
a second insulating layer disposed on the second metal layer;
a third metal layer disposed on the second insulating layer;
a third insulating layer disposed on the third metal layer;
a touch layer disposed on the third metal layer, wherein the touch units are located on the touch layer; and
wherein the touch wires are located on the third metal layer.

In one embodiment of the present disclosure, the touch panel includes:
a substrate;
a first metal layer disposed on the substrate;
a first insulating layer disposed on the first metal layer;
a second metal layer disposed on the first insulating layer;
a second insulating layer disposed on the second metal layer;
a touch layer disposed on the second metal layer, wherein the touch units are located on the touch layer; and
wherein the touch wires are located on the second metal layer.

According to another aspect of the present disclosure, a display device is provided and includes a touch panel as claimed in any one of claims 1 to 9.

Advantages in the present disclosure are that, a touch panel and a display device are provided by disposing at least two evenly distributed touch wires connected to each of the touch units, such that the signal voltages may be evenly transmitted in the touch units through the touch wires, thereby avoiding a problem of uneven display brightness within pixel regions corresponding to the touch units.

2 0 BRIEF DESCRIPTION OF DRAWINGS

In order to more clearly illustrate technical solutions in the present embodiments or the prior art, drawings used in a description of the embodiments or the prior art will be briefly described below. Obviously, the drawings in the following description are merely some embodiments of the present disclosure, and other drawings may be obtained from those skilled in the art without any creative work.

FIG. 1 is a schematic structural diagram of touch wires in a touch panel in the prior art.

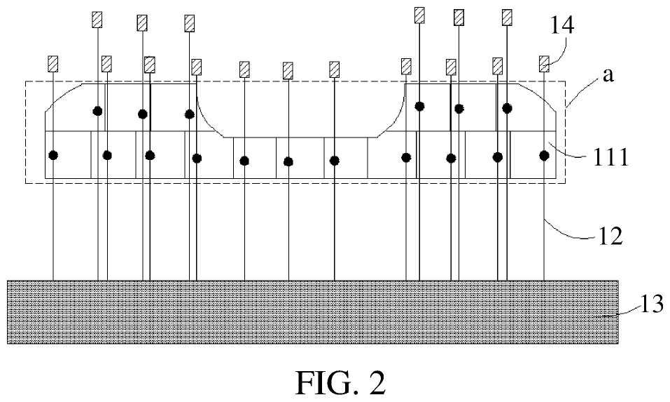

FIG. 2 is a schematic structural diagram of the touch panel in the prior art.

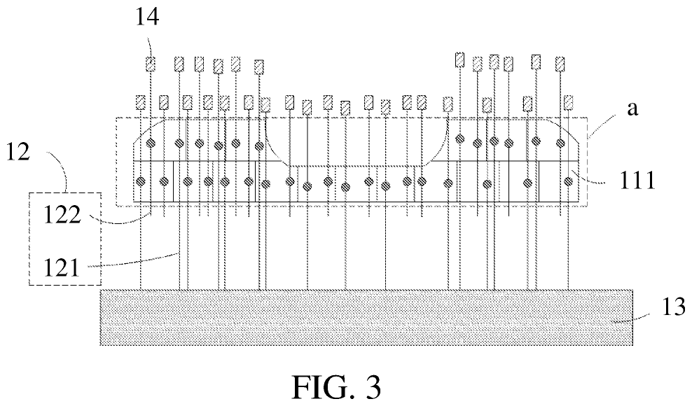

FIG. 3 is a schematic structural diagram of a touch panel according to an embodiment of the present disclosure.

### DETAILED DESCRIPTION OF PREFERRED EMBODIMENTS

The following description of each embodiment refers to the appended drawings for illustrating specific embodiments in which the present disclosure may be practiced. Directional terms as mentioned in the present disclosure, such as “up”, “down”, “front”, “rear”, “left”, “right”, “inside”, “outside”, “lateral”, etc., are merely used for the purpose of illustrating and understanding the present disclosure and are not intended to be limiting of the present disclosure. In the drawings, units with similar structures are denoted by the same reference numerals.

A touch panel and a display device are provided in the present disclosure. A problem that a signal voltage distribution in a pixel area corresponding to a single touch unit in existing touch panel is uneven, thereby causing uneven brightness, and that may be improved by the present embodiments.

The present disclosure will be further described below in conjunction with the accompanying drawings and specific embodiments.

As shown in FIGS. 2 to 3, a touch panel is provided according to an embodiment of the present disclosure, and includes: a touch unit array, a plurality of touch switches 14, a plurality of touch wires 12, and an integrated circuit board 13, wherein the touch panel comprises a display region and a non-display region around the display region.

The touch unit array comprises a plurality of touch units 11 distributed in the display region in an array manner.

Further, the display region comprises a shaped region a and a normal region, the shaped region a is located on one side of the display region away from the integrated circuit board 13, and the touch units 11 comprise a plurality of first touch units 111 and a plurality of second touch units 112.

The first touch units 111 are disposed in the shaped region a, the second touch units 112 are disposed in the normal region, the first touch units 111 are connected to the touch switches 14 via the touch wires 12, and the second touch units 112 are connected to the integrated circuit board 13 via the touch wires 12.

Understandably, an area of each of the first touch units 111 is different from an area of each of the second touch units 112, that causes the capacitances of the first touch units 111 and the second touch units 112 are different. In addition, because the shaped region a is far away from the integrated circuit board 13, a plurality of signal voltages of the first touch units 111 are greatly interfered by the capacitances, so that small touch squares with uneven brightness are generated between the first touch units 111 within the shaped region and affect a display effect of the display device.

The touch switches 14 are disposed in the non-display region and connected to the touch wires 12, the touch switches 14 are configured to receive the signal voltages and transmit the signal voltages to the touch wires 12.

The touch wires 12 connect the touch units 11 to the touch switches 14, and the touch wires 12 transmit the signal voltages to the touch units 11.

The integrated circuit board 13 is configured to provide the signal voltages to the touch units 11.

By disposing the touch switches, the signal voltages can be input on both sides of the touch unit array, thereby avoiding a great influence on the signal voltage due to the difference in the capacitances between the touch units 11, and alleviating a problem of differential display brightness between the touch units 11. However, if each of the touch units 11 merely outputs one the signal voltages via one of the touch wore, when the touch wires 12 are located on a same side of the touch units 11, a resistance inside one of the touch units 11 is too large. When the signal voltages are entered from one side of the touch unit 11, a divided signal voltage in a region opposite to the touch trace 12 is weak due to a voltage division of the resistance, which results in uneven brightness of a pixel region within a single touch unit 11. In order to solve above problem, some design are provided in the present disclosure as below.

Each of the touch units 11 is connected to at least two of the touch wires 12 that are evenly distributed within each of the touch units 11.

It should be explained that, at least two of the touch wires 12 are connected to the touch switches 14, that is, the touch units 11 can obtain a desired signal voltage via at least two of the touch wires 12. The uniform distribution of the touch wires 12 avoids the influence of the large resistance of the touch units 11 on the signal voltage distribution, thereby avoiding uneven brightness of the pixels in corresponding regions of the touch units 11.

Further, the touch switches 14 comprises a plurality of thin film transistors, each of the thin film transistors comprises a source, a drain, and a gate, wherein the gate is configured to receive a switch voltage for one of the touch switches 14, the source is configured to receive one of the signal voltages, and the drain is connected to one of the touch wires. When the display device is working to display, one of the touch switches is turned on or off by receiving the switch voltage of the touch switches 14. In addition, because one of the touch switches 14 transmits one of the signal voltages to one of the touch wires via the source and the drain, one of the touch units 11 can receive one of the signal voltages via one of the touch wires 12 when the one of the touch switches 14 is turned on.

Understandably, in an embedded touch panel, a touch unit array simultaneously has related functions to a common electrode, so that a reception of the signal voltage can further affect illumination of the display device.

Further, a number of the touch switches is one-to-one correspondence with a number of the touch switches.

Preferably, the first touch units 111 are disposed in the shaped region, the second touch units 112 are disposed in the normal region, the first touch units 111 and the second touch units 112 both are connected to the integrated circuit board 13 via the touch wires 12 and the touch switches 14, and an area of each of the first touch units 111 is different from an area of each of the second touch units 112.

In one embodiment, each of the first touch units 111 is connected to two of the touch wires 12 located on two sides within each of the first touch units 111; and two of the signal voltages are transmitted into each of the first touch units via two of the touch wires 12.

Preferably, each of the first touch units 111 is connected to m-numbered touch wires 12 evenly distributed within each of the first touch units 111, m is an integer greater than or equal to two; and one of the signal voltages are transmitted into each of the first touch units 111 via the m-numbered touch wires 12.

Preferably, the touch wires 12 comprises a plurality of first touch wires 121 and a plurality of second touch wires 122, the first touch wires 121 are connected to the touch switches 14 and the integrated circuit board 13, the second touch wires 122 are connected to the touch switches 13, and the touch wires 12 connected to the touch units 11 include one of the first wires 121.

It should be explained that, in one touch panel, one touch wire unit has idle pseudo touch wires, in addition to the touch wires. If the present disclosure is applied in the existing touch panel, which is as shown in FIG. 2, one of the pseudo touch wires away from the touch wires 12 may be selected and extends to the touch switches 14 and connects with the touch switches 14 to form a new touch wire 12. For illustration, the original touch wires 12 are noted as the first touch wires 121, and the other touch wires 12 modified by the pseudo touch wires are noted as the second touch wires 122, thereby simplifying preparation process of the touch panel.

In the existed touch panel, different types of touch panels have different structures, further restrictions can be made for this purpose, such as the touch panel includes:
a substrate;
a first metal layer disposed on the substrate;
a first insulating layer disposed on the first metal layer;
a second metal layer disposed on the first insulating layer;
a second insulating layer disposed on the second metal layer;
a third metal layer disposed on the second insulating layer;
a third insulating layer disposed on the third metal layer;
a touch layer disposed on the third metal layer, wherein the touch units 11 are located on the touch layer; and
wherein the touch wires 12 are located on the third metal layer.

In another embodiment, the touch panel includes:
a substrate;
a first metal layer disposed on the substrate;
a first insulating layer disposed on the first metal layer;
a second metal layer disposed on the first insulating layer;
a second insulating layer disposed on the second metal layer;
a touch layer disposed on the second metal layer, wherein the touch units are located on the touch layer; and
wherein the touch wires are located on the second metal layer.

According to another aspect of the present disclosure, a display device is provided and includes the touch panel of the present disclosure.

The working principle of the display device is similar to the working principle of the touch panel. Specifically, the working principle of the display device may be referred with the working principle of the touch panel mentioned as above and is not described herein.

Advantages in the present disclosure are that, a touch panel and a display device are provided by disposing at least two evenly distributed touch wires connected to each of the touch units, such that the signal voltages may be evenly transmitted in the touch units through the touch wires, thereby avoiding a problem of uneven display brightness within pixel regions corresponding to the touch units.

In summary, although the present disclosure has been disclosed in the preferred embodiments, the above preferred embodiments are not intended to limit the present disclosure. Those skilled in the art may make various changes and modifications without departing from the spirit and scope of the present disclosure. Therefore, the protection scope of the present disclosure is based on the scope defined by the claims.

1. A touch panel, comprising:
a touch unit array, a plurality of touch switches, a plurality of touch wires, and an integrated circuit board, wherein the touch panel comprises a display region and a non-display region around the display region;
wherein the touch unit array comprises a plurality of touch units distributed in the display region in an array manner;
wherein the touch switches are disposed in the non-display region and connected to the touch wires, the touch switches are configured to receive a plurality of signal voltages and transmit the signal voltages to the touch wires, and a number of the touch switches is one-to-one correspondence with a number of the touch switches;
wherein the touch wires connect the touch units to the touch switches, and the touch wires transmit the signal voltages to the touch units;
wherein the integrated circuit board is configured to provide the signal voltages to the touch units; and
wherein each of the touch units is connected to at least two of the touch wires that are evenly distributed within each of the touch units.

2. The touch panel as claimed in claim 1, wherein the touch switches comprises a plurality of thin film transistors, each of the thin film transistors comprises a source, a drain, and a gate; and the gate is configured to receive a switch voltage for one of the touch switches, the source is configured to receive one of the signal voltages, and the drain is connected to one of the touch wires.

3. The touch panel as claimed in claim 1, wherein the display region comprises a shaped region and a normal region, the shaped region is located on one side of the display region away from the integrated circuit board, and the touch units comprise a plurality of first touch units and a plurality of second touch units; and wherein the first touch units are disposed in the shaped region, the second touch units are disposed in the normal region, the first touch units and the second touch units both are connected to the integrated circuit board via the touch wires and the touch switches, and an area of each of the first touch units is different from an area of each of the second touch units.

4. The touch panel as claimed in claim 3, wherein each of the first touch units is connected to two of the touch wires located on two sides within each of the first touch units;
and two of the signal voltages are transmitted into each of the first touch units via two of the touch wires.

5. The touch panel as claimed in claim 3, wherein each of the first touch units is connected to m-numbered touch wires evenly distributed within each of the first touch units, and m is an integer greater than or equal to two; and one of the signal voltages are transmitted into each of the first touch units via the m-numbered touch wires.

6. The touch panel as claimed in claim 1, wherein the touch wires comprises a plurality of first touch wires and a plurality of second touch wires, the first touch wires are connected to the touch switches and the integrated circuit board, the second touch wires are connected to the touch switches; and the touch wires connected to the touch units include one of the first wires.

7. The touch panel as claimed in claim 1, further comprising:
a substrate;
a first metal layer disposed on the substrate;
a first insulating layer disposed on the first metal layer;
a second metal layer disposed on the first insulating layer;
a second insulating layer disposed on the second metal layer;
a third metal layer disposed on the second insulating layer;
a third insulating layer disposed on the third metal layer;
a touch layer disposed on the third metal layer, wherein the touch units are located on the touch layer; and
wherein the touch wires are located on the third metal layer.

8. The touch panel as claimed in claim 1, further comprising:
a substrate;
a first metal layer disposed on the substrate;
a first insulating layer disposed on the first metal layer;
a second metal layer disposed on the first insulating layer;
a second insulating layer disposed on the second metal layer;
a touch layer disposed on the second metal layer, wherein the touch units are located on the touch layer; and
wherein the touch wires are located on the second metal layer.

9. A touch panel, comprising:
a touch unit array, a plurality of touch switches, a plurality of touch wires, and an integrated circuit board, wherein the touch panel comprises a display region and a non-display region around the display region;
wherein the touch unit array comprises a plurality of touch units distributed in the display region in an array manner;
wherein the touch switches are disposed in the non-display region and connected to the touch wires, and the touch switches are configured to receive a plurality of signal voltages and transmit the signal voltages to the touch wires;
wherein the touch wires connect the touch units to the touch switches, and the touch wires transmit the signal voltages to the touch units;
wherein the integrated circuit board is configured to provide the signal voltages to the touch units; and
wherein each of the touch units is connected to at least two of the touch wires that are evenly distributed within each of the touch units.

10. The touch panel as claimed in claim 9, wherein the touch switches comprises a plurality of thin film transistors, each of the thin film transistors comprises a source, a drain, and a gate; and the gate is configured to receive a switch voltage for one of the touch switches, the source is configured to receive one of the signal voltages, and the drain is connected to one of the touch wires.

11. The touch panel as claimed in claim 9, wherein the display region comprises a shaped region and a normal region, the shaped region is located on one side of the display region away from the integrated circuit board, and the touch units comprise a plurality of first touch units and a plurality of second touch units; and wherein the first touch units are disposed in the shaped region, the second touch units are disposed in the normal region, the first touch units and the second touch units both are connected to the integrated circuit board via the touch wires and the touch switches, and an area of each of the first touch units is different from an area of each of the second touch units.

12. The touch panel as claimed in claim 11, wherein each of the first touch units is connected to two of the touch wires located on two sides within each of the first touch units; and two of the signal voltages are transmitted into each of the first touch units via two of the touch wires.

13. The touch panel as claimed in claim 11, wherein each of the first touch units is connected to m-numbered touch wires evenly distributed within each of the first touch units, and m is an integer greater than or equal to two; and one of the signal voltages are transmitted into each of the first touch units via the m-numbered touch wires.

14. The touch panel as claimed in claim 9, wherein the touch wires comprises a plurality of first touch wires and a plurality of second touch wires, the first touch wires are connected to the touch switches and the integrated circuit board, the second touch wires are connected to the touch switches; and the touch wires connected to the touch units include one of the first wires.

15. The touch panel as claimed in claim 9, further comprising:
a substrate;
a first metal layer disposed on the substrate;
a first insulating layer disposed on the first metal layer;
a second metal layer disposed on the first insulating layer;
a second insulating layer disposed on the second metal layer;
a third metal layer disposed on the second insulating layer;
a third insulating layer disposed on the third metal layer;
a touch layer disposed on the third metal layer, wherein the touch units are located on the touch layer; and
wherein the touch wires are located on the third metal layer.

16. The touch panel as claimed in claim 9, further comprising:
a substrate;
a first metal layer disposed on the substrate;
a first insulating layer disposed on the first metal layer;
a second metal layer disposed on the first insulating layer;
a second insulating layer disposed on the second metal layer;
a touch layer disposed on the second metal layer, wherein the touch units are located on the touch layer; and
wherein the touch wires are located on the second metal layer.

17. A display device, comprising a touch panel comprising:
a touch unit array, a plurality of touch switches, a plurality of touch wires, and an integrated circuit board, wherein the touch panel comprises a display region and a non-display region around the display region;
wherein the touch unit array comprises a plurality of touch units distributed in the display region in an array manner;
wherein the touch switches are disposed in the non-display region and connected to the touch wires, the touch switches are configured to receive a plurality of signal voltages and transmit the signal voltages to the touch wires, and a number of the touch switches is one-to-one correspondence with a number of the touch switches;
wherein the touch wires connect the touch units to the touch switches, and the touch wires transmit the signal voltages to the touch units;
wherein the integrated circuit board is configured to provide the signal voltages to the touch units; and
wherein each of the touch units is connected to at least two of the touch wires that are evenly distributed within each of the touch units.
